(19) United States
(12) Patent Application Publication
(10) Pub. No.: US 2012/0182245 A1
(43) Pub. Date: Jul. 19, 2012

(54) System And Method Of Using A Portable Touch Screen Device

(75) Inventor: Kevin Hutton, Del Mar, CA (US)

(73) Assignee: GOLDEN HOUR DATA SYSTEMS, INC, San Diego, CA (US)

(21) Appl. No.: 13/430,986

(22) Filed: Mar. 27, 2012

Related U.S. Application Data
(62) Division of application No. 12/580,389, filed on Oct. 16, 2009.

(51) Int. Cl. G06F 3/041

(52) U.S. Cl. 345/173

(57) ABSTRACT

A system and method of using a portable touch screen device (“PTSD”) in connection with an integrated emergency medical transport database system is disclosed. The PTSD may be used to quickly and accurately gather and preserve data regarding a patient and the transportation of the patient. In various embodiments data may be input into the PTSD in a standardized format by associating typing, voice, video, picture, or other files with predetermined data input categories. Standardized data may then be communicated by the PTSD, for instance wirelessly, to an integrated emergency medical transport database, after which the patient data is deleted from the PTSD to protect patient confidentiality.

### CROSS REFERENCE TO RELATED APPLICATIONS

This application is a divisional of U.S. patent application Ser. No. 12/580,389 filed Oct. 16, 2009, and claims priority thereto. The specification and drawings of patent application Ser. No. 12/580,389 are hereby incorporated by reference in their entirety.

### BACKGROUND OF THE INVENTION

1. Field of the Invention

This invention relates to a system and method of using a portable touch screen device (“PTSD”) in connection with an integrated database system. More specifically, this invention relates to a system and method of using a PTSD in connection with an integrated database system for the emergency medical transportation industry.

2. Description of the Related Technology

Documentation procedures in the medical transport industry have been based on an inefficient paper and pencil technology. Important information is frequently collected on loose sheets of paper. In the environment of emergency medical transport (i.e., in the field), little time is available to neatly chart and document all pertinent and required information on a single document. Dispatch data, demographic data and clinical data are normally tracked as fragmented pieces of information which are later coalesced into a complete patient chart. In many cases, these data include the same information, thus forcing the input of redundant information. The resultant chart is therefore vulnerable to being incomplete and unreliable. In a medical setting, incomplete information can lead to disastrous clinical results.

This same technology is used to support industry quality improvement and billing procedures and submit letters of transport justification. This paperwork is usually carried out at a later date, prolonging account receivable times in many instances to the point of compromising and jeopardizing service compensation. Inventory stocking and tracking is similarly a victim of extended turnover times and is often incomplete and inaccurate.

The fragmentation throughout the medical transport environment is also evident in the myriad of entities throughout the country practicing different standards of care and documentation. As is the case in other segments of the healthcare industry, even seemingly simple tasks of communicating among the various entities, as well as among sections of a single providing entity, is severely hampered by the lack of a common communication format. This is especially evident when certain aspects of the system (such as computerized clinical laboratory result displays) have been upgraded with a uniquely tailored computerized system, while the remaining functions are still performed in an archaic manner. While the upgraded system may be effective for one singular aspect, such as dispatching, lab reporting, or chart dictating, the remainder of the system does not improve its effectiveness due to the other archaic components.

Medical transport services suffer from a lack of understanding as to their effectiveness by governmental, academic and commercial organizations. Systems are needed to collect solid statistics on how these systems can save lives and justify their existence and growth. Furthermore, medical crew evaluations and areas for improvement can be compared to known benchmarks after statistics on past service become widely available.

To address the foregoing issues, fully integrated medical transportation database systems and aspects thereof have been disclosed in the following United States patents and published patent applications: U.S. Pat. No. 6,117,073, entitled Integrated Emergency Medical Transportation Database System, issued to Scott J. Jones and Kevin C. Hutton on Sep. 12, 2000; U.S. Pat. No. 7,233,905, entitled Billing Modifier Module For Integrated Emergency Medical Transportation Database System, issued to Kevin C. Hutton and Scott J. Jones on Jun. 19, 2007; United States Patent Application Publication number US 2007/0203742 A1, entitled Integrated Emergency Medical Transportation Database and Virtual Private Network System, published in the name of inventors Scott J. Jones, Rany Polany and Kevin C. Hutton on Aug. 30, 2007; United States Patent Application Publication number US 2007/0299689 A1, entitled Billing Modifier Module For Integrated Emergency Medical Transportation Database System, published in the name of inventors Scott J. Jones and Kevin C. Hutton on Dec. 27, 2007; and United States Patent Application Publication number US 2008/0126134 A1, entitled Integrated Emergency Medical Database System, published in the name of inventors Scott J. Jones and Kevin C. Hutton on May 29, 2008. All of the foregoing patents and publications are hereby disclosed and incorporated herein by reference for all that they teach, as if reproduced herein in their entireties.

While the above-disclosed fully integrated medical transportation database systems improve documentation processes, still further improvements are sought to the systems and methods used to gather information in the field and communicate it with the database systems. For example, improvements are sought with respect to speed and ease of use, quantity and quality of information gathered and communicated, and security of patient information.

Therefore, what is needed is a fast, easy-to-use and secure system and method of gathering high-quality information in the field and communicating that information into fully integrated medical transportation database systems.

### SUMMARY OF CERTAIN INVENTIVE ASPECTS

One aspect of the present invention is a portable touch-screen device adapted to gather and transmit information regarding a patient incident, wherein the portable touch-screen device comprises a data input field on the screen and a file creation field on the screen, wherein the portable touch-screen device is adapted to cause an electronic file containing information regarding the patient incident to be created in the portable touch-screen device and associated with the data input field when the data input field is touched and then the file creation field is touched. Numerous other features of such devices are further disclosed herein.

Another aspect of the present invention is a computerized integrated data management system for tracking a patient incident, comprising a portable touch-screen device adapted to collect audio and/or image information regarding the patient incident by touching the screen of the portable touch-screen device in a first set of predetermined locations in a first predetermined sequence, the portable touch-screen device being further adapted to wirelessly transmit the information within the computerized integrated data management system by touching the screen of the portable touch-screen device in a second set of predetermined locations in a second predetermined sequence. Related features to such a system are also disclosed.

A further aspect of the present invention is a method of using a portable touch-screen device in connection with a computerized integrated data management system for tracking a patient incident, the method comprising the steps of providing a portable touch-screen device adapted to gather information regarding a patient incident and wirelessly transmit that information to a computerized integrated data management system, entering information regarding the patient incident into the portable touch-screen device by touching the screen in a first set of predetermined locations in a first predetermined sequence; and wirelessly transmitting within the computerized integrated data management system the information regarding the patient by touching the screen in a second set of predetermined locations in a second predetermined sequence. Many related method steps are also disclosed herein.

### BRIEF DESCRIPTION OF THE DRAWINGS

FIG. 1 is a diagram illustrating the on-line computing environment of an example medical database system, including a portable touch-screen device, dispatch interface computer, server computer, backup computer, clinical and diagnosis interface computer, administrative interface computer and billing interface computer.

FIG. 2 is a flow diagram illustrating the overall process performed by an example medical database system.

FIG. 3 is a block diagram illustrating the flow of data among the dispatch module, the clinical module, and the billing module, in an example embodiment of the medical database system.

FIG. 4 is a flow diagram illustrating an example method and system of record creation using a portable touch-screen device in connection with a medical database system.

FIG. 5 is a flow diagram illustrating an example method and system of inputting data into a portable touch-screen device in connection with a medical database system.

### DETAILED DESCRIPTION OF PREFERRED EMBODIMENT

The following detailed description presents a description of certain example embodiments of the present invention. In this description, reference is made to the drawings wherein like parts are designated with like numerals throughout.

For convenience, the following detailed description is organized by first describing in general terms an example integrated database system for the emergency medical transportation industry, including Introduction, Hardware Overview, Software Initialization, Data Flow Between Modules and Description of Software Modules, and then a specific example of a System and Method of Using a PTSD in connection with such integrated database systems is described.

### Introduction—Example of an Integrated Database System for the Emergency Medical Transportation Industry:

In certain embodiments, the present invention may be used in connection with an object oriented, interactive, international, client-server or web-deployed service for the medical transport industry. The service may integrate all aspects of patient record documentation into a single complete electronic chart. A server computer may provide chart database information access to multiple transport providers simultaneously by securely transmitting, storing and maintaining standardized patient data, for instance, using guidelines set forth by the Scrambling Standards Organization. Individual transport-providing entities, such as helicopter and ambulance companies, may obtain coded access to such a server via phone lines with a modem equipped personal computer. The present invention provides further access to such a server with wireless digital communication devices and networks, such as wireless laptop computers, personal data assistants (PDA), wireless phones, or portable touch-screen devices, such as an Apple iPhone, or any other devices that can communicate information wirelessly to any combination of wireless and wired networks to ultimately reach a server. Security may be maintained by assigning each entity a unique code or identifier. Integrated Services Digital Network (ISDN) lines, Digital Satellite Systems (DSS), dedicated trunk lines (T1, T3, etc.), cable modem, DSL, or digital wireless systems are examples of systems that may be used for communication.

Each crew member involved in a patient's chart documentation, such as dispatcher, flight/transport nurse, paramedic and physician, as well as administrator and collector, may possess coded access to chart portions relevant to their responsibilities and level of care provided. The chart may then be electronically generated from the compendium of the information entered in a standardized fashion and in accordance with minimum industry documentation requirements and the inventory of financial health care standards. The system may then provide complete and accurate chart documentation and maintain internal consistency between each separate module. Further, any sentinel events may automatically be referred to the appropriate, responsible party. A sentinel event might be any action during an encounter that might require a further review. Examples of sentinel events are scene times exceeding 40 minutes, nonsensical or inconsistent data entry by an emergency transport crew member, supply shortages for equipment not utilized or repeated claim denials. The portable touch-screen device 11 may automatically create a sentinel event in response to a predefined condition being met by the information regarding the patient incident, like the events disclosed above. In these events the portable touch-screen device may wirelessly transmitting a signal corresponding to the sentinel event, for instance by text messaging (SMS). In some embodiments, sentinel events can be created, made anonymous and sent to alternate web based services to perform non-punitive error management directly from the PTSD 11.

Billing may be submitted electronically to the appropriate party in an appropriate format that reduces the accounts receivable times for each patient encounter. Letters of justification may automatically be generated as well as follow up letters and utilization review reports. Inventory reports and lists of necessary base supplies and medicines may also be electronically updated to appropriate supply centers and administrators. Customized and research reports may also be provided rapidly.

Data security and an automatic backup may be provided. Although chart data is normally made the property of the respective transport service provider, a system may retain non-proprietary data to provide industry benchmarking, quality assurance analysis and clinical research opportunities. Such standardized data collection and documentation may furthermore enable the development of an Emergency Medical Services data library to assist in the justification and legislation of governmental preventive policies for public safety.

### Hardware Overview in an Example Integrated Database System for the Emergency Medical Transportation Industry:

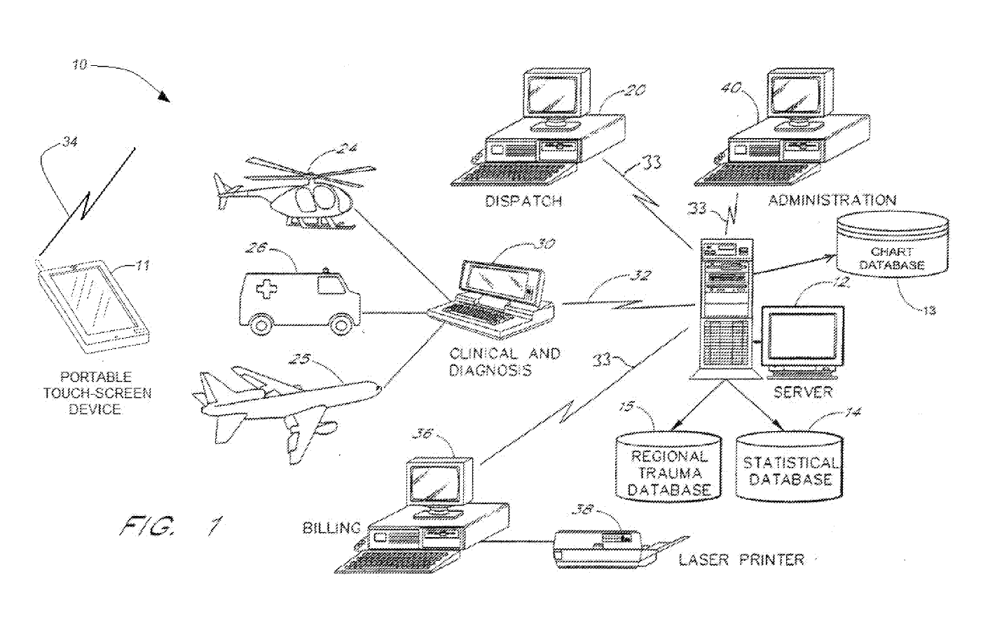

FIG. 1 provides an overview of the computer hardware involved in one embodiment of the medical database system. An example medical database system 10 includes a portable touch-screen device (“PTSD”) 11. A PTSD 11 may lack a physical keyboard, instead having a multi-touch screen that renders or creates a virtual keyboard when necessary. An example of a touch-screen device 11 that may be used is the iPhone, an Internet and multimedia enabled smartphone designed and marketed by Apple, Inc. A PTSD 11 such as an iPhone may function as a camera phone (also including text messaging and visual voicemail), a portable audio and video media player, and an Internet client (with email, web browsing, and Wi-Fi connectivity). In one embodiment an iPhone 3GS that further includes video capability may be used as a PTSD 11. Where an iPhone or similar device is used as a PTSD 11, almost all input into the PTSD 11 is given through the touch screen, which understands complex gestures using multi-touch. It is understood that the invention disclosed herein is in no way limited to using one example product as the PTSD 11, such as the iPhone, but rather includes any devices, systems or methods encompassed by the claims. In the example where an iPhone is used as a PTSD 11, the PTSD 11 conveniently comprises an integrated audio, video, and image capture in one consumer device that integrates with integrated database systems for the emergency medical transportation industry. Interaction techniques may enable the user of a PTSD 11 such as an iPhone to move the content up or down by a touch-drag motion of the finger. For example, zooming in and out of web pages and photos may be done by placing two fingers on the screen and spreading them farther apart or bringing them closer together, a gesture known as “pinching”. Scrolling through a long list or menu may be achieved by sliding a finger over the display from bottom to top, or vice versa to go back. In either case, the list may move as if it is pasted on the outer surface of a wheel, slowly decelerating as if affected by friction. In this way, the interface may simulate the physics of a real object. Other user-centered interactive effects of a PTSD 11 may include horizontally sliding sub-selection, a gesture known as “swiping,” as well as vertically sliding keyboard and bookmarks menus, and widgets or three-dimensional images that rotate on the screen to allow touch-inputs to be associated with points on various sides of the multi-dimensional image. Menu bars may found at the top and/or bottom of the screen when necessary. In menu hierarchies, a “back” button in the top-left corner of the screen may display the name of the parent folder. Various optional aspects of portable touch-screen devices 11 have been disclosed, including multifunctionality, multitasking, accelerometers, proximity detectors, ambient light sensors, global positioning sensors, compasses, and the like. At least some of the foregoing features have been described in United States Patent Application Publication number US 2006/0097991 A1, entitled Multipoint Touchscreen, published in the name of inventors Steve Hotelling, et al. on May 11, 2006; United States Patent Application Publication number US 2009/0213083 A1, entitled Simulation Of Multi-Point Gestures With A Single Pointing Device, published in the name of inventors George R. Dicker et al. on Aug. 27, 2009; and United States Patent Application Publication number US 2009/0194344 A1, entitled Single Layer Mutual Capacitance Sensing Systems, Device, Components and Methods, published in the name of inventors Jonah A. Harley et al. on Aug. 6, 2009. The technology disclosed in the foregoing patent applications is just an example of what is known in the art regarding portable touch-screen devices, and the above-identified patent applications are hereby disclosed and incorporated herein by reference for all that they teach, as if reproduced herein in their entireties.

A medical database system 10 may include a server computer 12. The server computer 12 can be based on any well-known microprocessor such as those manufactured by Intel, Motorola, IBM or others. The server computer should be able to enable rapid simultaneous access to many users of the system. In one embodiment, the server computer 12 is an Intel Pentium III class computer having at least 256 Megabytes of RAM and a 10 gigabyte hard disk drive and a 500 MHz processing speed. An alternative, for example, would be a web based computer environment using Java, J2EE, and an Oracle database deployed as an application server provider over the Internet. Of course, many other standard or non-standard computers may support various embodiments of the medical database system 10.

Such a database application may be programmed in, for instance, ACIUS's 4th Dimension (4D) language and used in conjunction with the 4D Server and Client program. Also, another alternative computer environment is Microsoft Corporation's Visual Basic language with C++ middleware, and the BackOffice SQL Server program. It could therefore run in a standard Windows/Macintosh point-and-click office environment, and requires no additional, specialized software programming from the user. Of course, other standard or non-standard computer environments may support various embodiments of the medical database system 10.

As illustrated, the server computer may access a chart database 13. A chart database 13 may store the previously described electronic charts corresponding to patients that have utilized emergency medical transportation. A server computer may also access a statistical database 14 to store and extract statistical information from data entered during patient encounters. Collected statistics might include, for example, average scene and transport times, number of transport requests per demographic region and time of year, average number of advanced procedures performed by crew members and number of complications encountered. In addition, the database 14 could hold information relating to the average length of time to process claims by category and payment plan.

A server computer could also be linked to a regional trauma database 15. Such a database 15 could hold information relating to local trauma centers, emergency medical practice and other local trauma-related information.

A dispatch module on the server computer 12 could be accessed via an interface to a dispatch computer 20, which might reside, for example, at a dispatch center that receives the initial call to deploy an emergency medical team. The dispatch computer 20 could provide just a communications interface to the server computer 12 so that it acts as computer terminal, or it could contain a portion of the dispatch module.

Based on the scene location and needs of the patient, a dispatch center might deploy a helicopter 24, airplane 25, ambulance 26, or other transportation mechanism. The dispatch computer 20 may communicate with software for collecting information on the patient encounter and scheduling and deploying a crew to assist the injured patient. Within the medical database system 10, the helicopter 24, airplane 25 or ambulance 26 may include a portable computer or computing device 30 (note that the portable computer 30 may be any electronic device that includes computing capability) that is used by the emergency medical team during the patient encounter. A wireless connection 32 can be made by the portable computer 30 to the server computer 12 to update the database 14 after any data has been entered. In conjunction with or in lieu of computing device 30, other ways of communication with the server 12 can be used, such as, for instance, PTSD 11. The portable computer 30 and/or PTSD 11 may include clinical and diagnosis modules to assist the emergency medical team in treating the injured patient, or can act as terminal(s) to communicate with these modules on the server computer 12. As will be explained below, the clinical and diagnosis modules can help the emergency medical team determine the proper diagnosis and treatment of the patient.

The medical database system 10 may also include a billing computer 36 in communication with the server computer 12. The billing computer 36 may interface with the server computer 12 to run the billing module for tracking charges. The software billing module can be stored directly on the billing computer 36 or, alternatively, stored on the server 12 and accessed via the billing computer 36. The billing module may be used to track charges, inventory, and medical equipment. In addition, it may be used during the patient encounter for providing billing functions within the medical database system 10. The billing computer 36 may communicate with a printer 38 or other output device or driver to provide reports and bills to hospitals, patients and medical centers, by paper or electronically.

An administration computer 40 may interface with the server computer 12 to provide or run administrative reports. These reports might relate to the statistical information contained in the statistical database 14. In addition, the administration computer 40 might run reports that relate to payroll, inventory, flight/transport training or many other administrative issues.

It should be noted that the dispatch interface computer 20, portable computer 30, billing computer 36 administration computer 40 and PTSD 11 can each communicate with the server computer 12 through a variety of mechanisms, as indicated by connection paths 32, 33 and 34. For example, a wireless LAN or cellular network may optionally connect each device with each other device. In one embodiment, dedicated or dial-up phone lines can be used to communicate between one or more of the different devices. Communication paths 32, 33 and 34 may all be the same or may each be different from the other with respect to each device, or any combination thereof, and paths 32, 33 and 34 may include any combination of mediums by which electronic signals may be communicated, including by hard wire/cable, radio frequency, Bluetooth, microwave, digital satellite, and networks such as the Internet, and may include virtual private networks (VPNs), which are further discussed in United States Patent Application Publication number US 2007/0203742 A1, entitled Integrated Emergency Medical Transportation Database and Virtual Private Network System, published in the name of inventors Scott J. Jones, Rany Polany and Kevin C. Hutton on Aug. 30, 2007, which is incorporated herein by reference.

### Software Initialization in an Example Integrated Database System for the Emergency Medical Transportation Industry:

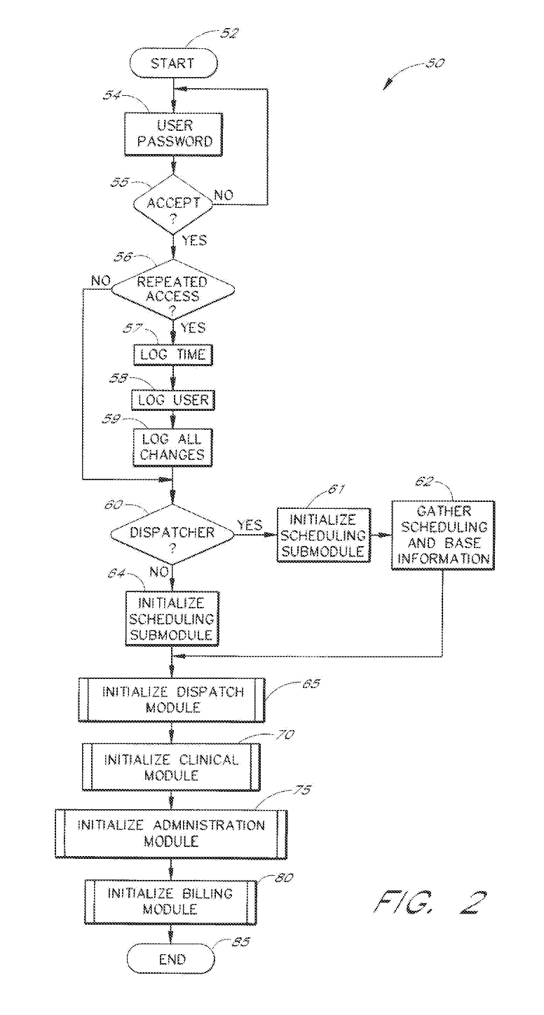

Referring now to FIG. 2, an overall process 50 of initializing the various software modules within an example medical database system 10 is shown. Although FIG. 2 illustrates the initialization of all software modules in the system, it should be realized that each module can be initialized within a separate computer. For example, the dispatch module can be initialized within the dispatch computer 20 while the billing module is initialized within the billing system 36.

The example process 50 begins at a start state 52 and then moves to state 54 wherein a user password is requested. If the user password is accepted at a decision state 55, the process 50 moves to a decision state 56 to determine whether this is a repeated access to the system. However, if the password is not accepted at the decision state 55, the process 50 returns to state 54 to re-request the user password.

If a determination is made at the decision state 56 that this is a repeated access, the process 50 moves to a state 57 to log the time of the access and then to a state 58 to log the identity of the user making the access. A log of the access changes to the system are then logged at a state 59. The process 50 then moves to a decision state 60 wherein a determination is made whether a dispatcher has initiated this call. However, if a determination is made at the decision state 56 that this was not a repeated access, the process 50 moves directly to the decision state 60.

If a determination is made at the decision state 60 that a dispatcher initiated this call, the process 50 moves to state 61 wherein a scheduling submodule is initialized. The scheduling submodule, as discussed above, tracks base information, crew schedules, helicopter flight/transport times and the like. The process then moves to state 62 wherein the scheduling and base information from the dispatcher is shared and extracted into the clinical and diagnosis modules, and thereafter sent to the clinical and diagnosis computer interface 30 (FIG. 1). The process 50 then moves to a process state 65 wherein the dispatch module is initialized. However, if a determination was made at the decision state 60 that a dispatcher did not originate the call, the process 50 moves to state 64 and initializes the scheduling submodule. The process 50 then moves to process state 65 and initializes a dispatch module.

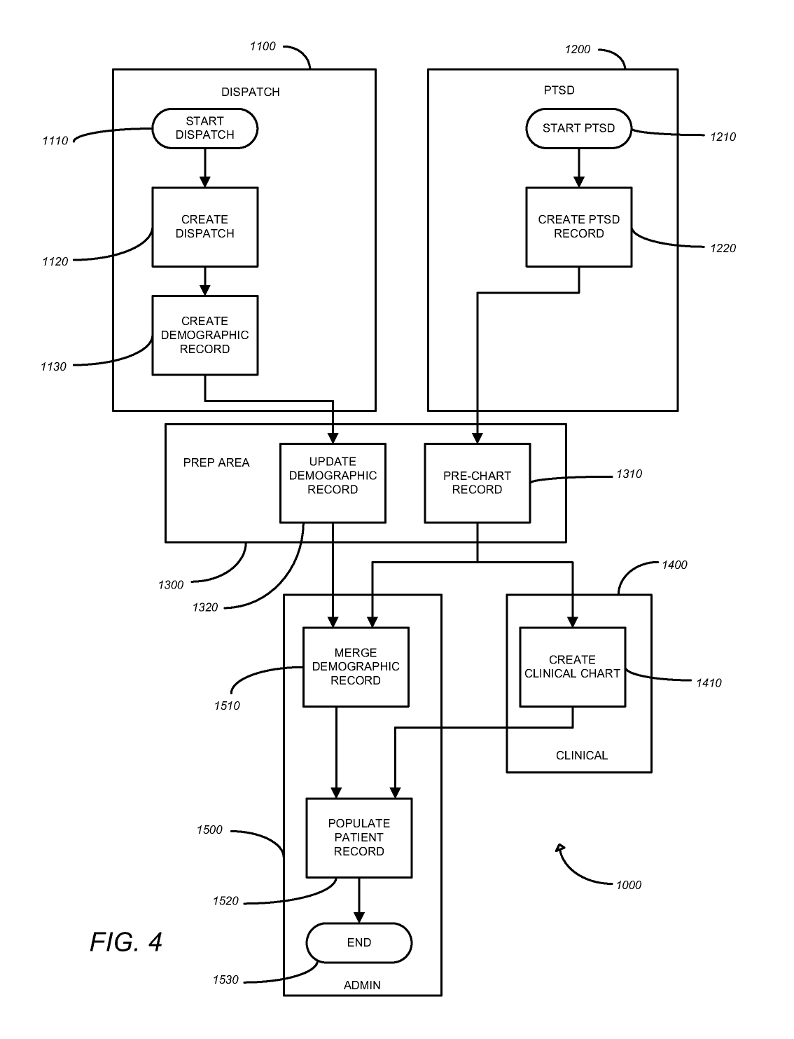

The example dispatch module may be divided into four interrelated submodules: Schedule, Standby, Flight/transport and Transfer (not shown). The Scheduling submodule accomplishes the task of preparing schedules for the respective transport bases of medical service. The scheduling submodule may be responsible for tracking dispatch, flight/transport crew members, base physician, pilot (co-pilot), and stationed helicopters in service for a given shift. Data can be entered well in advance and updated up to the time a flight/transport or other transportation is actually dispatched. The process 65 of initializing and running a dispatch module is explained in more detail with reference to FIG. 4 in U.S. Pat. No. 6,117,073, entitled Integrated Emergency Medical Transportation Database System, issued to Scott J. Jones and Kevin C. Hutton on Sep. 12, 2000, all of which is incorporated herein by reference.

The example scheduling submodule shares shift information already entered in the scheduling module to generate a flight/transport record based on the date, time, and base from which the flight/transport takes place. As mentioned above, upon flight/transport dispatch, the dispatcher will receive the name of the current base physician, crew and helicopter information for verification.

The example standby submodule enables the dispatcher to collect information regarding the accident scene location, ground contacts, basic patient scenario and demographics prior to committing and dispatching a flight/transport. This submodule allows agencies requesting medical transport services to provide an early warning, verify the need for transport and hence shorten the response and flight/transport time to the accident scene.

The example transfer submodule coordinates patient transfers from one location to another. For example, a critical patient may need to be transported from a local hospital to a specialty hospital in order to receive a unique operation. The Transfer module manages the information associated with the patient transfer, such as origin, destination, purpose and the like.

The example flight/transport submodule constitutes the main portion of the example dispatch module, and records information pertinent to the flight/transport proper. Flight/transports are tracked through timed and recorded position checks in accordance with Federal Aviation Agency (FAA) and Commission on Accreditation of Medical Transport requirements. Accident scenes are recorded with rendezvous and landing zone locations, address and zip codes as well as standard map coordinates, such as Thomas Brothers Reference points. In addition, waypoint/longitude-latitude location, the requesting agency, any ground contacts, and an appropriate communication frequency and the reason for call are all recorded by the flight/transport submodule.

Further, the type and nature of call, base hospital, and name of the closest and receiving hospitals may be collected. Mileage traveled and time stamping, including scene time, flight/transport time and specialty times, such as crew change and pick up times as well as on site times, may be calculated and recorded automatically from the information provided and dispatch feedback from flight/transport crew. In addition, the reason and time for flight/transport diversions and re-routings and elected ground transports with justification and alternate plans may be entered into the system as well. Multiple flight/transports may be orchestrated and recorded in parallel, while dispatcher and/or base physician change shifts during a flight/transport—all data may be constantly updated. When backup vehicles are required and dispatched, the flight/transport information may be transferred automatically from the primary responding crew to the backup crew.

Flight/transport information may be saved after verification as a dispatch record with a monthly flight/transport number. A monthly Association of Air Medical Services (AAMS) report or any other required/or operational report can then be automatically generated. Flight/transport information can be canceled at any time, as well as deleted completely from the database with the appropriate option.

Once the dispatch module has been initialized at the process 65, a clinical module may be initialized at a process 70. The example clinical module is also divided into several submodules: patient demographics, basic incident description, treatment rendered prior to medical service arrival, general assessment including vital signs, intake and output as well as trauma scores, physical exam by systems, impression and diagnosis, treatment including medications and advanced procedures, en route events, quality assurance, justification of transport, and patient disposition. A specialized neonatal submodule can also be accessed if necessary.

Although any submodule can be accessed to begin a chart, the submodules may normally be ordered in the traditional clinical format. Patient demographic information may be taken first automatically from the dispatch data, if available. The patient information may be completed first; including flight/transport reference, date, base, scene, reason for transport, scene, landing and scene times, patient name, age, sex, weight and race, allergies, current medications, past medical history, place of exam, language barrier existence, type of call, nature of call, response such as night flight/transport, in/out county intensive care unit to intensive care unit (icu-icu), transport team only, out county emergency department to emergency department (ed-ed) or emergency transport service with no charge. These parameters are all important to integrate into a compliant bill.

Incident information, including the occurrence time, incident type (for example, motor vehicle accident, gun shot, fall, stabbing, drowning, loss of consciousness, pedestrian, cerebrovascular accident, chest pain, arrest, burn), type and description of accident (damage, extrication, loss of consciousness, other) can then be entered. Next, any treatment that was provided prior to medical crew arrival may be entered into the system for purposes of determining an accurate E-code (event code). The name of first responders, along with the level of care provided and type of immobilization, airway management, intravenous access, cardiopulmonary resuscitation, medications and other treatments may be recorded. The patient's Glasgow, CRAMS and Champion trauma scores may be recorded separately, and in such a manner that consistency amongst various sources is assured by mutual exclusivity data rules.

The patient's vital signs, including systolic/diastolic blood pressure, pulse rate, respiratory rate, pulse oximetry, fluid intake/output along with the time of measurement can be recorded, and diagnostic data may be extracted using data tags such as tagging a physical exam finding also as an impression to be offered in the diagnostic module. In addition, the arrival time of aircraft or other transportation on the scene, departure and hospital arrival times are once again displayed. Other important data pertinent to vital signs can be recorded in this module, to improve diagnostic accuracy and compliant billing.

The physical examination portion is also divided into sections related to particular physiological and anatomic components. A default standard normal examination for each system may be selected, wherein all or portions thereof can be selected. Results can be typed, or selected from standard examination result options. For example, the first examination could be a neurological examination with input options such as alert, oriented times three, full recall, pupils equal and round and reactive to light and moving all extremities. The next examination is a skin exam with options such as good color, warm and dry, capillary refill less than 2 seconds, pulses well palpable. A head, eyes, ears, nose and throat exam can be performed, followed by a neck and chest examination. A cardiac examination having options such as regular rate and rhythm, no murmur rubs or gallop, and normal sinus rhythm on the monitor can be performed. The next examination can be abdominal, followed by pelvic and extremities examinations. As these data choices are selected they can be tagged as impression, significant finding or associated findings so they can be addressed as a possible ICD-9 or E-code diagnosis in the diagnostic module for capture and prioritization.

Once the results of these standard body examinations are received by the system, the physicians diagnoses may be entered. In addition, the system may generate pre-set diagnoses based on the results it has received during the clinical examination. Many of the results can be automatically recorded by having the monitoring equipment hooked directly into the portable computer system. Industry standard ICD-9 billing codes for each diagnosis and E-Code can then be automatically determined, prioritized and recorded by the system. These codes are used by the billing module to generate statements to the patient.

A treatment plan may next be entered into the system by the emergency team. The treatment that occurred prior to the arrival of the medical crew may automatically be completed from the aforementioned section, if provided. Equipment used (Electrocardiogram, vital sign monitor, pulse oximeter, suction devices, ventilator, etc.), respiratory management, as well as intravenous access by crew, and neurological immobilization techniques (cervical collar, long/short back board, ked sled, etc.) and miscellaneous techniques (temperature measurements, bulb syringe, suction catheter, etc.) may all be recorded. All medications other than those applied under the standard advanced cardiac life support protocols may be recorded from an extensive list within the system. Advanced procedures with procedure-specific documentation can be recorded accurately. These include, but are not limited to, intubation, chest tube placement, pericardiocentesis, invasive line placement, advance cardiac life support, special medication administration, Mannitol infusion or Solumedrol administration.

Special documentation for the advanced procedure of intubation/cricothyrotomy may include the use of rapid sequence intubation techniques, route of successful intubation along with tube size, best visualization procedure, depth at which tube is secured, and confirmation technique of tube placement. Identification of successful and unsuccessful intubation medical crews can also be tracked as a way to identify possible crew training issues. Pulse oximetry recordings can be performed before or after the procedure. Extensive choices may be available to comment on the procedure and note any complications that were encountered by the medical team. The medications used during this procedure may be recorded in a special medications submodule.

The special medications submodule may record, in addition to rapid sequence intubation (RSI) medications, the name and dose of the medication given along with the identification of the administering crew member in accordance with Joint Commission on Accreditation of Health Care Organization Requirements (JCAHO). Any comments associated with the drug administration and ensuing complications can be recorded in this submodule.

Special documentation for any chest tube placement procedure may be included in the system to record the patient's indication, type of technique (tube versus needle), identification of successful and unsuccessful performers, location of placement, size of tube and time of placement. In addition, the aspirate type and amount are recorded. Again, pulse oximetry measurements pre and post procedure may be recorded into the system. Comments and complications ensuing from the procedure may be recorded as above.

For pericardiocentesis, the procedure, time, identification of successful and unsuccessful performers, catheter and syringe sizes, aspirate amount and type, patient improvement as well as comments and complications (vascular damage, air embolus, etc.) may all be included in the data acquisition by the system.

Invasive line procedure documentation may include identification of successful and unsuccessful performing crew, site of placement, type of access line, time of placement and comments and complications encountered. This can be used later for medical crew evaluations and training.

The advanced cardiac life support documentation may include the beginning and end of resuscitation times, medications in the order and dose administered, electricity administered (defibrillation, cardioversion), as well as other comments relating to the events that occurred. Vital signs and times are recorded or directly downloaded from the recording monitor.

The administration of particular drugs such as Morphine are tightly controlled by the Drug Enforcement Agency (DEA) or otherwise by law and require special documentation. The medical database system can complete this documentation by collecting the identification of the administering crew member, the patient's Glasgow Coma Score pre and post administration, dose given, indications and comments and complications encountered.

Similarly, Solumedrol and Mannitol administration also requires extra documentation, including identification of crew administering the medication, estimated level of neurological injury, dose and time given, as well as comments and complications encounters (allergic reaction, hypotension, etc.).

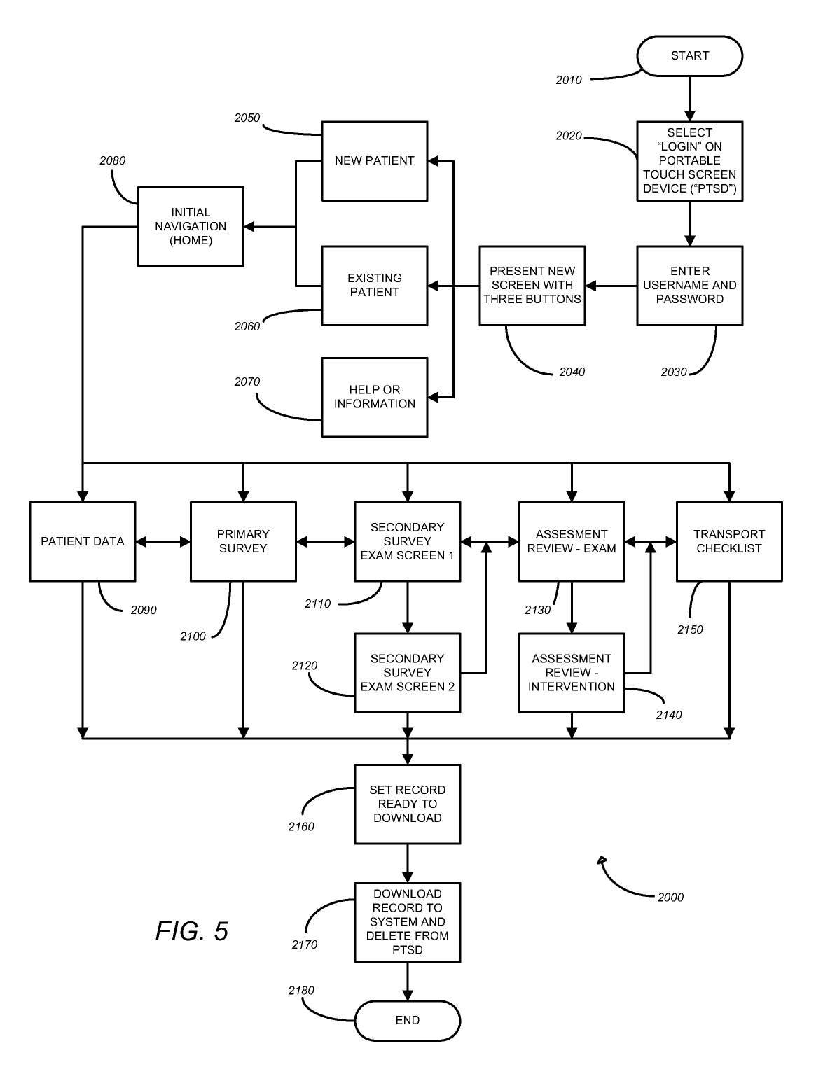

Other data may be collected en route in sequential format from the incident scene to the destination. The data collected can include the changed/unchanged patient status, name of person to whom report is given, name of accepting physician, and follow up status of transported patient. The process 70 of initializing and running a clinical module is explained in more detail with reference to FIG. 5 in U.S. Pat. No. 6,117,073, entitled Integrated Emergency Medical Transportation Database System, issued to Scott J. Jones and Kevin C. Hutton on Sep. 12, 2000, all of which is incorporated herein by reference.

The example process 50 then moves to a process 75 and initializes an administration module for collecting and processing the information from the clinical encounter. The hierarchical structure of the system enables it to perform administrative services along with quality assurance as well. Indeed, from the chart's data, standard administrative reports can be automatically generated and sent to the appropriate personnel. Furthermore, a letter of justification for transport and interventions rendered may be automatically generated in the required format from the chart components. With this same service, HIPPA compliant thank you letters and letters of follow up may be directed as well to the responsible parties involved. The Emergency Medical Service can be provided with key preventive information on environmental health and public safety hazards encountered on scene by the transport crew. Also, internal reports and memos can be disseminated across the network of computers. And sentinel events such as those associated with delays in care or failure to provide adequate care and safety, may immediately and automatically be called to the attention of the appropriate administrator to provoke corrective action. The administration module process 75 is explained in more detail with reference to FIG. 8 in U.S. Pat. No. 6,117,073, entitled Integrated Emergency Medical Transportation Database System, issued to Scott J. Jones and Kevin C. Hutton on Sep. 12, 2000, all of which is incorporated herein by reference.

Once the administration process has begun and the patient information is collected by the system 10, the example process 50 moves to a process state 80 and initializes the billing module of the medical database system. The billing component may take advantage of the extensive patient information collected in the aforementioned modules. The demographic documentation may be automatically incorporated from the dispatch and clinical modules. Precise billing for level of care provided to the patient may be exactly accounted for as was noted and recorded in the clinical component. In addition, procedures requiring the use of extensive inventory, such as intubations, chest tube placements, etc., may be automatically evaluated for use of the required specific paraphernalia for completeness on the chart sheet for inventory and budgeting purposes. When medications are administered, the billing component may automatically select the number of inventory unit amounts to be accounted for from the total dose administered and the amount wasted as well as required by, e.g., Drug Enforcement Agency (DEA) policy. The bill can then be processed electronically in the required format to the correct agency.

The same data used for billing therefore, may also be used to update stock inventory on the respective transport vehicle and base after each encounter, to ensure adequate equipment supplies. Coupled to the supplier's inventory list, this information can automatically signal the need for delivery of equipment to the required base. Once the billing module is initialized at process 80, the overall example process 50 terminates at an end state 85.

### Data Flow Between Modules in an Example Integrated Database System for the Emergency Medical Transportation Industry:

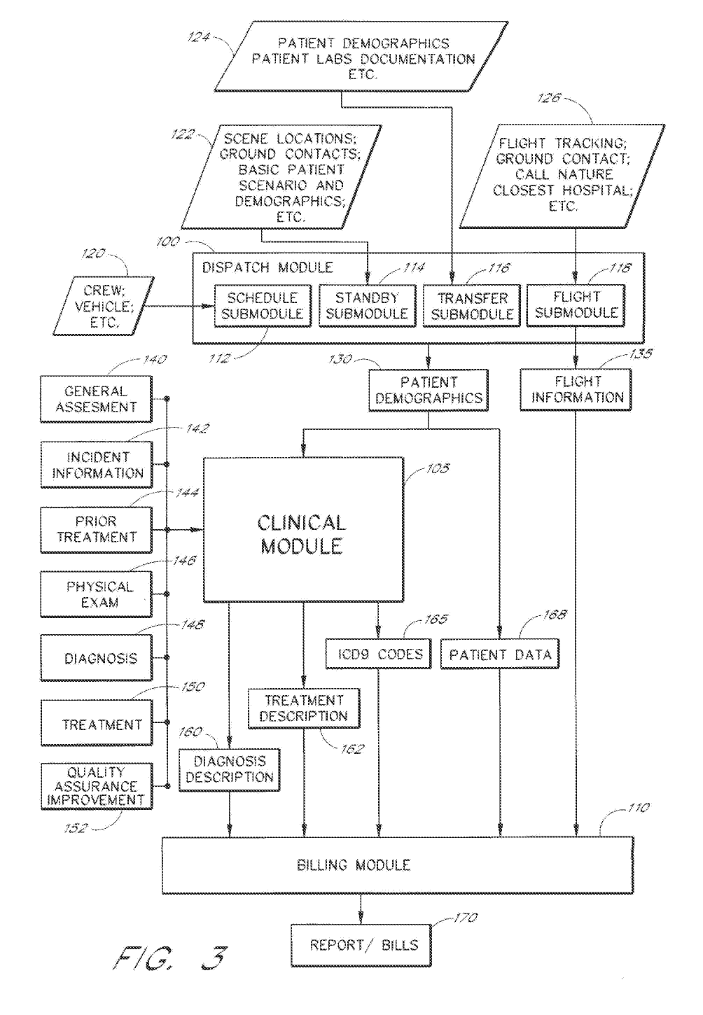

Referring now to FIG. 3, a block diagram of one embodiment of the data flow between the various modules within an example medical database system is illustrated. FIG. 3 illustrates the flow of data between a dispatch module 100 (hereafter referred to as the dispatch module), clinical module 105 and billing module 110. The dispatch module 100 includes a scheduling submodule 112, a standby submodule 114, a transfer submodule 116 and a flight/transport submodule 118. These various submodules process information received into the overall dispatch module 100. For example, crew information 120 is processed within the schedule submodule 112. In addition, scene information 122 is processed within the standby submodule 114.

Patient demographics and patient lab information 124 may be processed within the transfer submodule 116. Flight/transport tracking and other transportation information 126 may be processed within the flight/transport submodule 118. Once the various submodules within the dispatch module 10 have processed their respective information, a set of patient demographic information 130 and flight/transport information 135 may be made available to the remaining modules. For example, some of the patient demographic information 130 may be imported into the clinical and compliant ICD-9 coding module 105 (hereafter, clinical or diagnosis module 105).

In addition, many other pieces of data may be placed within the clinical module 105. For example, the general assessment 140 of the patient that is taken by the emergency medical team may be imported into the clinical module for further processing. In addition, other incident information 142 such as the type of incident (car accident, motorcycle accident, etc.) may be sent to the clinical module 105. Prior treatment information 144 obtained from a physical exam of the patient or other information may also be sent to the clinical module 105.

The prior treatment information might be important in determining whether the patient had already been treated for similar injuries thereby affecting the clinical diagnosis. Information collected from the physical exam 146 at the scene may also be sent to the clinical module 105. In addition, any diagnosis 148 from the attending emergency medical team can be sent to the clinical module 105. It should be noted that the medical database system 10 may also provide an ICD-9 coded diagnosis based on the physical exam information 146 and other information within the clinical module 105. This is explained in more detail in U.S. Pat. No. 6,117,073, entitled Integrated Emergency Medical Transportation Database system, issued to Scott J. Jones and Kevin C. Hutton on Sep. 12, 2000, all of which is incorporated herein by reference.

Information relating to the treatment 150 of the patient may also be sent to the clinical module 105. The medical database system 10 may also include a quality assurance database 152 which allows the emergency medical team to make suggestions or other comments that may be useful in additional treatments or incidents. For example, if the emergency medical team notes that a particular series of exam results has led to a unique ICD-9 diagnosis, this information can be input into the diagnosis module 105. Thus, these same exam-related diagnostic results are forwarded as a suggested diagnostic module to be prioritized into the billing module 110. The next time these same physical exam results are seen in a patient, the new diagnosis can be suggested to the emergency medical team.

Once the clinical module 105 has received its necessary information, data may be output to the billing module 110. For example, a description of the diagnosis 160, a treatment description 162 or ICD-9 codes 165 can be sent from the clinical module 105 to the billing module 110. As is well known in the art, ICD-9 codes are a set of unique codes referring to most well known medical diagnosis. These codes are used throughout the insurance industry to obtain payment for various medical procedures, and determine who should be responsible for payment. In addition to the data from the clinical module 105, patient data 168 can be obtained from the patient demographic information 130. The flight/transport information 135 can also be integrated into the billing module 110. This information may then be used within the billing module 110 to generate reports, bills and electronic forms 170. As can be expected, these reports and bills are sent to the various insurance companies and insurance providers, as well as the patient (sometimes in various required formats). Billing module 110 may be supplemented with a Billing Modifiers Module, as further discussed in United States Patent Application Publication number US 2007/0299689 A1, entitled Billing Modifier Module For Integrated Emergency Medical Transportation Database System, published in the name of inventors Scott J. Jones and Kevin C. Hutton on Dec. 27, 2007, all of which is incorporated herein by reference. Thus, the medical database system 10 is an example of an integrated system for providing many services, meeting various required formats and optimizing maximum payment.

### Description of Software Modules in an Example Integrated Database System for the Emergency Medical Transportation Industry:

Details of example software modules, including dispatch module process 65 (FIG. 2), clinical module process 70 (FIG. 2) (including the physical exam process and the process of determining a diagnosis and rank), administration module process 75 (FIG. 2) (including collecting a treatment plan process), and billing module process 80 (FIG. 2) are disclosed in U.S. Pat. No. 6,117,073, entitled Integrated Emergency Medical Transportation Database System, issued to Scott J. Jones and Kevin C. Hutton on Sep. 12, 2000, all of which is incorporated herein by reference.

Example System and Method of Using a PTSD in Connection with an Integrated Database Systems for the Emergency Medical Transportation Industry:

Above is described in general terms an example of an integrated database system for the emergency medical transportation industry. Following is a description of a specific example of a system and method of using a portable touch screen device in connection with an integrated database system for the emergency medical transportation industry. These descriptions are provided to illustrate example applications of the present invention, not to limit the scope of the invention. The scope of the invention is limited only by the claims, which are broader than any specific examples provided.

Turning to FIG. 4 in view of FIG. 1, a flow diagram is provided illustrating an example method and system of record creation 1000 using a portable touch-screen device 11 in conjunction with the example integrated medical database system 10. In the event of a medical emergency, an emergency medical transportation provider is contacted, triggering a dispatch or communication center to initiate a dispatch 1110, which triggers the creation of a dispatch communication 1120 to a helicopter 24, airplane 25, ambulance 26, or other transportation mechanism. The dispatch department 1100 also may create an initial demographic record 1130 of the patient, all of which is shown as part of dispatch block 1100.

The medical service providers in the helicopter 24, airplane 25, ambulance 26, or other transportation mechanism have a PTSD 11, that they initialize 1210 upon being dispatched. When the medical service providers are en route to and arrive at the medical emergency location, they may use the PTSD 11 to create a PTSD record 1220 regarding the patient and any other circumstances regarding the emergency and the transportation, all of which is shown as part of PTSD block 1200. In some embodiments, the PTSD 11 is not in communication with any other components of the system 10 during transit. This is sometimes referred to as “airplane mode.” In other embodiments, the PTSD 11 is in communication 34 with other components of the system 10 during transit, in which case information regarding demographic record 1220 can be received and transmitted to and from other optional parts of the system during transit, such as a server 12, dispatch 20, clinical and diagnosis computer 30, billing 36 and administration 40. The PTSD 11 may also collect other data en route and associate it with the PTSD record 1220, such as times and locations (via Global Position System, or GPS), ambient conditions, and information regarding the transportation mechanism, such as vehicle condition, temperature, fluid and gas temperatures, pressures, and amounts, altitude, and the like (if the PTSD 11 is in communication with the electronics of the transportation mechanism, either by hard wire or wirelessly), direction and movements (via compass and accelerometer), and any other information the PTSD 11 can detect and record. GPS functionality, accelerometers, proximity, and other sensors incorporated in PTSD's can generate data used to delineate specific actions that speed data entry, track crew location, or change the operating capabilities of the device 11. Data collected from these sensors may also be used to monitor flight data.

Upon arrival at the scene of the medical emergency, and thereafter as the medical personnel attend to the patient, including in some embodiments during subsequent travel to a medical facility, in addition to all the example information noted above, yet additional information may be manually entered into the PTSD 11 and optional clinical and diagnosis computer 30, for instance regarding analysis and treatment of the patient, while additional information may be received from dispatch 1100 to update the demographic record 1320. A pre-chart record 1310 may be initialized by the PTSD 11 during this period, all which is shown as prep area 1300. It should be noted that PTSD 11 may work in conjunction with or replace computer 30, such that in various embodiments tasks indicated to be performed by PTSD 11 may be shared between PTSD 11 and computer 30.

The information captured by the PTSD 11 through the foregoing processes may be referred to as captured data. Captured data in the PTSD 11 may be used in conjunction with other sources of data, such a dispatch 1100 and/or optional clinical and diagnosis computer 30, to make further data entry, for instance by clinical 1400 and admin 1500, more specific, internally consistent, and faster for the end user. In some embodiments captured data may be abstracted by a remote secondary data entry specialist to insure standardization and compliant initial entry, and then verified, amended, or reworked by a documenting clinician. With data entry and processing happening in parallel, as shown in the parallel information flow paths in FIG. 4, information flow and processing is more robust and faster than without the PTSD 11.

The pre-chart 1310 may be transmitted wirelessly or otherwise from the PTSD 11 to the clinical department 1400 to begin creation of a clinical chart 1410. The demographic information captured in the pre-chart record 1310 of the PTSD 11 can likewise be transmitted wirelessly or otherwise to the administration department 1500, where it may be combined with, compared to, resolved with, and otherwise merged 1510 with demographic information that originated from dispatch 1100 and which may have been updated 1320 at the prep area 1300.

The administration department 1500 may then receive the clinical chart 1410 from the clinical department 1400 and combine that information with the merged demographic information 1510 to populate a patient record 1520. Once the patient record 1520 is populated with all the information available from the emergency medical transport system 10, the process is terminated 1530. Thus, the system 1000 provides parallel information gathering and dissemination by utilizing the PTSD 11 in parallel with information obtained from dispatch 1100. The system 1000 further provides complementary and potentially overlapping methods of obtaining demographic data, which can help to create a more complete and accurate patient record 1520. The system 1000 can also be used to collect whatever myriad forms of information a PTSD 11 can collect and associate that information with a patient record 1520, and/or with quality control and statistical databases. And the system 1000 is just an example of the systems that could be employed using PTSD's in connection with integrated database systems for the emergency medical transportation industry.

A method of utilizing sample aspects of an example PTSD system 2000 will now be described with reference to FIG. 5 in view of FIGS. 1-4. The PTSD 11 is activated 2010, for instance upon dispatch 1120. A screen may then appear on the PTSD 11 with various images that when touched activate links. For instance, one or more links may be provided to a website or contact information for the emergency medical transportation company. To maintain security, a login link 2020 may be provided, where pressing the login link 2020 brings up a new screen 2030 with username and password fields. Clicking in these fields may cause an image of a keyboard to appear, so that the user can touch the images of the keys to type-in their username and password. In one embodiment, when typing the username and password, each typed letter turns into an asterisk after being displayed for a few seconds. After entering the username and password, the user may touch an image of a login button on the PTSD 11, which, if the username and password were correct, may bring up a new screen 2040 with for instance images of three other buttons, new patient 2050, existing patient 2060, and help or information 2070.

Clicking new patient 2050 may create a new PTSD record 1220, as well as connect information such as date, time, phone number, and user to the new record for future use. Clicking existing patient 2060 will search for patient records that are stored on the PTSD 11. To ensure security, patient records may be deleted from the PTSD 11 automatically after the PTSD downloads or syncs its patient record to the system 10 in compliance with HIPAA privacy security requirements. Clicking the help or information image 2070 may take the user to medical reference information, real-time information regarding medical facilities automatically-determined by the PTSD to be nearby, direct dial-out capability, web link capability, program contact information, protocol and policy information, equipment troubleshooting, customer service contacts, triage sheets, improvement requests, and user tips, for example.

Clicking new patient 2050 or existing patient 2060 may bring up an initial navigation “home” page 2080, which may include images of buttons for patient data 2090, primary survey 2100, secondary survey 2110, assessment review 2130, and transport checklist 2150. Each button may be a different color that corresponds to the color the screen will turn when that function is selected, i.e., color-coded buttons. Also appearing on the border of the home page 2080, for instance at the bottom of the screen, may be smaller images of certain action buttons. For example, one button may correspond to a camera, and pressing that button may cause the PTSD 11 to take a picture or video or audio plus video, and attach that file to the last data input clicked on. A camera icon would then appear at the visual location of that data input, and clicking on that icon would cause the picture or video to replay. Thus a visual relationship and link is created between pictures or videos and corresponding data fields. Similarly, a “record” action button may exist to record audio, such as dictation, which would link the audio file to the last data input clicked on, likewise creating an active audio icon at the visual location of that data input. Further action buttons may be provided for, e.g., creating text messages and/or making phone calls. In one embodiment an action button is provided that directly calls support services for the medical transportation company. Such “action” buttons may appear in the border of the screen, like a frame on an Internet web page, not only on the home page 2080 but also on subsequent data collection pages such as 2090, 2100, 2110, 2120, 2130, 2140 and 2150. A home page icon/link and a help or information icon/link may also appear, for instance in the corners, of some or all screens.

Clicking on the button for patient data 2090 may bring up a page with numerous data input buttons at various locations on the screen of the PTSD 11. Data input buttons may include, for example: incident type; nature; age/sex; patient identification; transport description; mechanism; care prior to arrival; sending decision; and receiving doctor. This data may be used to drive chart wizards to create pertinent graphical user interfaces (GUI) by sex, age, nature, and incident type in both PTSD's 11 and other interfaces of the system 10. Using the action buttons described above, data can be gathered quickly by clicking on a data input button, such as patient identification, then clicking on the camera button, and taking a picture of the patient's driver's license. Then, adjacent the patient identification data input button, a camera icon will appear. Clicking on that icon would bring up the picture of the patient's driver's license, thereby quickly and accurately gathering the patient's identification data in the field, i.e., in the prep area 1300. The driver's license information can be automatically entered into the system through conventional optical character recognition (“OCR”) scheme. And some driver's licenses include a bar code that can be optically read to access the license holder's personal information. The camera or other optical input device on the PTSD can be used to input the bar code and process it. Driver's licenses may also include a magnetic strip, much like a credit card. That strip may contain the personal information of the license holder. Thus, the PTSD may be outfitted with a magnetic strip reader/writer to access the information, and could optionally write pertinent medical information to the strip, which could then be downloaded in a future medical event. Similarly, the other data input buttons can be clicked, such as receiving doctor, then the “record” button can be clicked, and the user can just say the name of the doctor. The PTSD 11 will then record what was spoken and visually associate that audio file with an icon, such as a speaker icon, next to that data input button. Thus, while in alternative embodiments data inputs may be typed-in with a touch-screen keyboard, the present invention allows for much faster and more efficient data gathering using the combination of action buttons with data input buttons.

Additional features on the patient data page 2090 may include a picture of the patient appearing on the page. Insurance cards could also be photographed and associated with a data input button. Further, clicking and holding down any data input button may bring up a pop-up window with information about that data input, such as data definition or a documentation guide to aid dictation, such that the user could hold down their click on the text and also record audio at the same time while reading the pop-up. The input of all data may be standardized for easier transfer.

In some embodiments, moving between screens 2090, 2100, 2110, 2120, 2130, 2140 and 2150 may be accomplished by touching the screen and sliding one's finger to the side, a technique sometimes referred to in connection with PTSD's as a lateral swipe, which causes the adjacent screen to slide into view very quickly. Thus, in such embodiments the user can laterally swipe the screen of the PTSD 11 to bring up the next screen in the example sequence, primary survey 2100. Primary survey 2100 may include data input buttons for airway, breathing, circulation, disability, motor exam, and sensory exam, for example Like the other data input screens, action buttons can be used to populate these data points with audio, picture and video files, which may have time, geographic location, and other markers automatically associated with those files. In some embodiments, the data inputs on the primary survey 2100 may be linked to databases of medical diagnostic and treatment information, such that the PTSD 11 may process the information and suggest treatments or conditions to monitor in view of the data entered.

Proceeding to the next screen, secondary survey exam screen 1 2110, for instance with a lateral swipe, a new data input screen will be presented that may seek additional information specifically tailored to the age and/or sex of the patient and/or the nature of the condition, which information may have been obtained with the prior screens. For example, in some embodiments the secondary survey exam screens 1 and 2, 2110 and 2120, respectively, display a rotatable three-dimensional image of the human body, which can be rotated left and right for instance by sliding the user's finger left and right along the bottom of the image. By spreading apart or pinching one's fingers on the screen in certain embodiments, as disclosed in the iPhone-related patent applications incorporated herein, the image of the human body can be zoomed-in our out, as needed to locate specific areas of the body for data gathering. This “pinching” zoom feature may be common to any of the touch-screen embodiments disclosed herein.

In the presently discussed embodiments the image of the human body presented on the screen may be different based on the age and/or sex of the patient and/or the nature of the condition, or any other variable. In some embodiments the image of the human body can be positioned then touched at a location corresponding to a location of interest on the actual patient, and then an action button pressed to take a picture or video of that location on the patient's body, or to dictate information regarding that location. Icons corresponding to the type of files created then appear at those locations on the image of the human body, and can be clicked at any time to review the files. In some embodiments clicking on the icons on the image of the human body brings up a pop-up list of issues to select from, such as a laceration, contusion, abrasion, deformity, or open fracture, for example. And then for each such selection a choice may be made by pushing one of three additional buttons on the same pop-up: major finding, associated finding, or impression. As with the other data inputs, the PTSD 11 records the data in the patient record 1220 and may begin to build a chart 1310. Categorizing and weighing the findings in this way facilitates appropriate prioritization of the issues to be addressed. Further, identifying entered data as a major finding, associated finding, or impression, and then prioritizing these identifications facilitates later conversion of the information to what is referred to in the art as an ICD-9, or medical condition code. This saves time and effort and prevents mistakes when creating ICD-9's.

A second secondary survey exam screen 2120 may be provided wherein clicking on icons on the image of the human body brings up a pop-up list of interventions that may have occurred with respect to that location, such as airway, vascular, ACLS, catheter, and medication interventions. Clicking on such interventions further builds the chart 1310 of data in the PTSD 11.

Next are assessment screens 2130, 2140 corresponding to the exams and interventions, respectively. These screens may each include a toggle button to switch back and forth between each other. The exam assessment review screen 2130 may include text indicating the patient's age, sex and nature of the condition, as well as a picture of the patient for identification. In one embodiment there may be up to five impressions and/or findings listed on screen 2130, which may be reordered / re-prioritized by clicking and dragging one above another. In certain instances impressions should not have ICD-9 codes associated with them at this point in the process. Upon clicking each of the listed impressions and findings on screen 2130 there are in one example three assessment buttons to choose from: (1) standard/negative PE; (2) positive PE finding; and (3) not evaluated. The user doing the assessing can, upon clicking each impression or finding, review the data and files associated therewith, such as audio files of dictations and pictures. Based on the user's review of this information they may select one of the three buttons to provide their assessment, or lack thereof.

Screen 2140 provides the user with an interface to assess the interventions recorded on screen 2120. In one embodiment there may be up to five interventions listed on screen 2140, which may be reordered/ re-prioritized by clicking and dragging one above another. Additional files, such as .wav audio files may be permitted to be appended to the listed interventions by clicking the intervention and then clicking the action button for audio recording. Upon clicking each of the listed interventions on screen 2140 there are in one example three assessment buttons to choose from: (1) CQI; (2) Justification; and (3) Financial. Each of those three buttons may link to live information provided by the emergency medical transport company or others. Selecting critical issues may result in a text and/or voice message being automatically sent form the PTSD 11 to designated administrative personnel at administration 40. The financial button may be used to capture, for instance, additional demographics data.

The next screen in one embodiment is a transportation checklist 2150. A transportation checklist screen 2150 may include such data input buttons as: flight briefing/patient preparation; turn over (of patient's valuables), records, forms left; consent form (signed/type); reason for transport; level of service; demographics; confirmed address/photo; loaded mile deviations; justification/medical necessity; closest appropriate facility (which may provide a pop-up with links to interactive maps and satellite images of closest facilities, along with key capabilities and contact information); quality assurance and safety issues; as well as an “other” category. As with the other data input screens, each of the foregoing data input buttons may be populated by pressing the button then pressing an action button and creating, for instance, an audio file by dictation. Any items remaining on the checklist as unresolved may be noted as exceptions to be addressed at other work flow points by other parts of the care continuum.

In certain circumstances patient signatures may be required to be collected in connection with compliant billing procedures, assignment of insurance benefits, consent for transport, and advanced beneficiary notification. Accordingly, as a separate screen or as part of any other screen, the PTSD 11 may include a data entry interface that is adapted to receive and digitally record the signature of a person, such as the patient. Alternatively or additionally, any other biometric data regarding a person, such as the patient, that may be sensed by the PTSD 11, or by a sensor used in connection with the PTSD 11, may be digitally recorded and used in connection with the record (e.g., finger prints, retinal scans, or any other sensing of a characteristic sufficiently unique to an individual). Such a data entry interface for PTSD 11 may include a stylus or any other means that a user could utilize to enter their signature data or other distinguishing mark or information into the PTSD 11.

Once all the desired information has been entered into the PTSD 11, which, as shown in FIG. 5, may involve fewer than all the steps described above, a button or other activation on the PTSD 11 may be selected to set the patient's record ready to download 2160 by any communication means 34, including wirelessly, to the system 10. Once the patient record in the PTSD 11 is set to download 2160, the user may then elect, for instance by pushing a button or other activation mechanism, to download 2170 the patient record 1220 to the system 10. Upon confirmation that the information has been transmitted, the record 1220 will typically be automatically deleted from the PTSD 11 to protect the confidentiality of patient information consistent with, e.g., the privacy provisions of the federal Health Insurance Portability and Accountability Act (HIPAA).

Information transfer 2170 may be prioritized based on, for instance, data size and speed of available Internet connection. In some embodiments information may be transferred via different mediums based on data size and available network speed and bandwidth. Various mediums that a PTSD 11 may be able to utilize to transfer data may include, for instance, telephone, email, instant messaging, and text messaging (SMS). However, to control unauthorized transmission of protected health information, the communication functionality of the portable touch-screen device 11 may be partially or fully restricted with respect to telephone, text messaging, email, or instant messaging communications, except to support specifically allowed communications and data transfer.

After the download 2170 the PTSD 11 may be deactivated or turned off 2180. Otherwise a PTSD 11 could be lost, stolen, or otherwise compromised and patient information improperly disclosed. As used herein the term button includes a physically movable object and/or a virtual button on a touch-screen device.

While the invention has been described in connection with specific embodiments thereof, it will be understood that it is capable of further modification, and this application is intended to cover any variations, uses, or adaptations of the invention following, in general, the principles of the invention and including such departures from the present invention as would be understood to those in the art as equivalent and the scope and context of the present invention is to be interpreted as including such equivalents and construed in accordance with the claims appended hereto.

1. A portable touch-screen device adapted to gather and transmit information regarding a patient incident, wherein the portable touch-screen device comprises:
a data input field on the screen; and
a file creation field on the screen;
wherein the portable touch-screen device is adapted to cause an electronic file containing information regarding the patient incident to be created in the portable touch-screen device and associated with the data input field when the data input field is touched and then the file creation field is touched.

2. The portable touch-screen device of claim 1, wherein the electronic file is represented by an icon appearing near the data input field upon creation of the electronic file.

3. The portable touch-screen device of claim 2, wherein touching the icon causes the electronic file it represents to open and reveal information contained in the electronic file.

4. The portable touch-screen device of claim 1, wherein the data input field comprises an image representing at least a portion of a human body.

5. The portable touch-screen device of claim 4, wherein the image representing at least a portion of a human body appears three-dimensional and may be moved by touching the screen.

6. The portable touch-screen device of claim 1, wherein the portable touch-screen device is adapted to wirelessly transmit information in the electronic file regarding the patient incident to a computerized integrated data management system for tracking patient incidents when the screen is touched in a predetermined location.
